(19) United States
(12) Patent Application Publication
(10) Pub. No.: US 2011/0209509 A1
(43) Pub. Date: Sep. 1, 2011

(54) Magnetic Barrel Lock Assembly

(76) Inventors: Mark Nickeas, Lake Sherwood, CA (US); Martin Nickeas, Oxnard, CA (US); Frank L. Gentile, Seymour, CT (US)

(21) Appl. No.: 13/034,499

(22) Filed: Feb. 24, 2011

Related U.S. Application Data
(60) Provisional application No. 61/308,466, filed on Feb. 26, 2010.

(51) Int. Cl. E05B 47/02

(52) U.S. Cl. 70/276

(57) ABSTRACT

A magnetic barrel lock assembly comprises a lock body that defines a chamber having a first end and a second end that is opposite the first end. A plunger is located within the chamber and is moveable between a locked position and an unlocked position. A lock magnet is located between the plunger and the first end of the chamber. A resilient member is configured to bias the plunger toward the first or second end of the chamber. A detent is configured to be extendable when the plunger is in the locked position and retractable when the plunger is in the unlocked position. Positioning a key magnet near the lock magnet moves the plunger to the unlocked position such that the detent may retract.

### CROSS REFERENCES TO RELATED APPLICATIONS

This application claims priority to U.S. provisional application No. 61/308,466 filed Feb. 26, 2010, which is hereby incorporated by reference as if fully set forth herein.

### STATEMENT REGARDING FEDERALLY SPONSORED RESEARCH

Not applicable.

### BACKGROUND

The present disclosure relates generally to a barrel lock assembly. More particularly, the disclosure describes a magnetic barrel lock assembly configured to move between a locked and an unlocked position due to magnetic interaction with a corresponding magnetic key.

Many conventional barrel locks include internal lock components that are engaged by a key inserted into an opening in the barrel lock. This general barrel lock configuration incorporates a number of precision elements that must work in concert to ensure proper operation of the barrel lock. In addition, the opening in the barrel lock hampers the operational life and ultimate security afforded by the barrel lock. For instance, debris, such as dust, water, and other contaminants can enter the barrel lock through the opening and foul the internal lock components. Furthermore, nefarious characters exploit the key opening in efforts to tamper with and defeat the security aspects of the barrel lock.

In light of at least the above considerations, a need exists for a barrel lock assembly having improved construction and operation.

### SUMMARY

In one aspect, a magnetic barrel lock assembly comprises a lock body that defines a chamber having a first end and a second end that is opposite the first end. A plunger is located within the chamber and is moveable between a locked position and an unlocked position. A lock magnet is located between the plunger and the first end of the chamber. A resilient member is configured to bias the plunger toward the first or second end of the chamber. A detent, is configured to be extendable when the plunger is in the locked position and retractable when the plunger is in the unlocked position. Positioning a key magnet near the lock magnet moves the plunger to the unlocked position such that the detent may retract.

The above and other aspects of the disclosure will be apparent from the description that follows. In the detailed description, preferred example embodiments will be described with reference to the accompanying drawings. These embodiments do not represent the full scope of the invention; rather, the invention may be employed in many other embodiments. Reference should therefore be made to the claims for determining the full breadth of the invention.

### BRIEF DESCRIPTION OF THE DRAWINGS

FIG. 1 is a partial section view of an example magnetic barrel lock assembly illustrating a magnetic key engaged and a plunger still in a locked position.

FIG. 2 is a partial section view of another example magnetic barrel lock assembly illustrating a magnetic key engaged and a plunger in an unlocked position.

FIG. 3 is an end view of an example keyed opening.

FIG. 4 is an example key/plunger polarity code configuration.

FIG. 5 is another example key/plunger polarity code configuration.

FIG. 6 is a partial top view of an example interlock configuration.

FIG. 7 is a cross section along line 7-7 of FIG. 6.

### DETAILED DESCRIPTION OF THE PREFERRED EXAMPLE EMBODIMENT

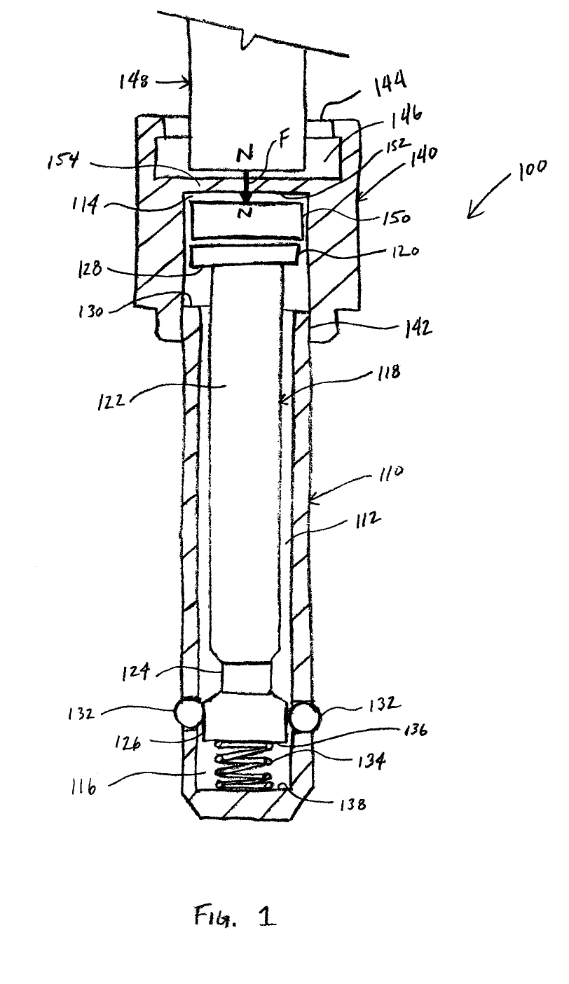

A first example magnetic barrel lock assembly (100) is shown in FIG. 1. In the example configuration illustrated, the magnetic barrel lock assembly (100) includes a lock body (110) that is cylindrically shaped. The lock body (110) defines a chamber (112) generally having a first end (114) and a second end (116) opposite the first end (114). The lock body (110) is preferably metallic (e.g., hardened steel) to provide resistance to cutting and deformation; however, certain applications may allow the lock body (110) to be constructed from plastic or other non-metallic materials.

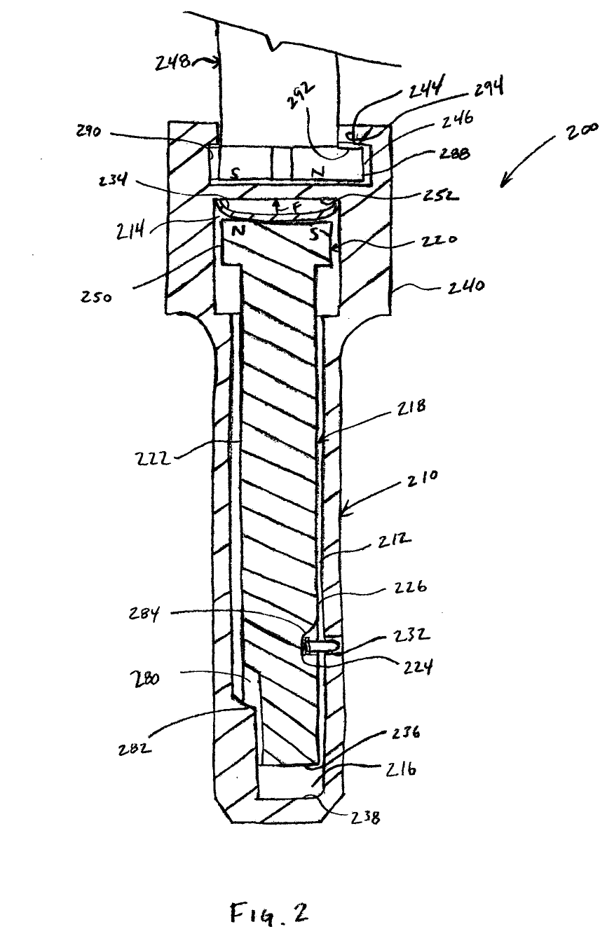

A plunger (118) is located within the chamber (112) such that the plunger (118) shown in the example embodiment can be moved axially between a locked position (shown in FIG. 1) and an unlocked position (shown in FIG. 2 with reference to an alternative example embodiment). The plunger (118) is also cylindrical to provide a compatible form factor with the cylindrical chamber (112) formed within the lock body (110). The lock body (110), chamber (112), and plunger (118) may be configured with any number of similar or distinct form factors provided the plunger (118) is capable of operation within the chamber (112), that is, the plunger (118) can move between the locked and unlocked positions during operation of the magnetic barrel lock assembly (100). Furthermore, the plunger (118) is preferably metallic to provide sufficient robustness; again, however, when application requirements allow, the plunger (118) may be constructed from plastic or any other suitable non-metallic materials.

The plunger (118) includes a head portion (120) near the first end (114) of the chamber (112), a shaft portion (122) adjacent the head portion (120), a recess (124) adjacent the shaft portion (122), and a lock portion (126) near the second end (116) of the chamber (112). The head portion (120) includes a lip (128) configured to engage a rim (130) formed by the lock body (110) when the plunger (118) of the magnetic barrel lock assembly (100) is moved into the fully unlocked position (not shown).

The recess (124) is formed by a neck between the shaft portion (122) and the lock portion (126), and is configured to receive and engage one or more detent(s) (132) when the plunger (118) is in the unlocked position (shown in FIG. 2) and the detent (132) is retracted. In the example embodiment illustrated in FIG. 1, the detents (132) include a pair of balls incorporated as understood by one of ordinary skill in the art and are shown extended. Alternatively, or in addition, the detent(s) (132) may comprise pins, blocks, and the like. The lock portion (126) is configured to engage the detents (132) when the plunger (118) is in the locked position and prevent the detents (132) from retracting into the chamber (112); as a result, the magnetic barrel lock (100) is inhibited from axial movement when engaged with a mating lock member, such as the panel lock for a utility access box (not shown), as is understood by one of ordinary skill in the art.

In the example magnetic barrel lock assembly (100) illustrated in FIG. 1, a resilient member (134) is located between an end face (136) of the plunger (118) and an end face (138) of the chamber (112) near the second end (116). The resilient member (134) is shown as a compression spring, but may take on a variety of other forms, such as, a spring washer or an elastomeric member. The resilient member (134) is configured to bias the plunger (118) toward the first end (114) of the chamber (112) and maintain the magnetic barrel lock assembly (100) in the locked position until desired.

In the example embodiment illustrated in FIG. 1, the lock body (110) includes a cap (140) that engages (e.g., is welded to) a first end (142) of the lock body (110) and defines the first end (114) of the chamber (112). In addition, the cap (140) defines a keyed opening (144) providing restricted access to a key cavity (146). As shown in FIG. 1, the keyed opening (144) is generally circular to allow access by a circular key magnet (148) through the keyed opening (144) and into the key cavity (146) toward the first end (114) of the chamber (112). The cap (140) is also preferably metallic and similarly resistant to tampering. The cap (140) may be integrally formed with the balance of the lock body (110) (e.g., as shown in FIG. 2) and seals the chamber (112), and components therein, to prevent debris from fouling the operation of internal components. Furthermore, tampering with the internal operation of the magnetic barrel lock assembly (100) is inhibited as no opening is present.

With continued reference to the example embodiment shown in FIG. 1, a lock magnet (150) is located between the head portion (120) of the plunger (118) and an end face (152) of the chamber (112) near the first end (114) of the chamber (112). The lock magnet (150) is configured to magnetically interact with the key magnet (148) such that when the key magnet (148) is positioned into the key cavity (146) near the lock magnet (150), a lock magnet polarity and a key magnet polarity will repel the lock magnet (150) away from the key magnet (148). Therefore, axially fixing the key magnet (148) within the key cavity (146) results in the lock magnet (150) being urged in the general direction of arrow F on FIG. 1, and thus moves the plunger (118) axially within the chamber (112). The plunger (118) in FIG. 1 is shown prior to being urged by the lock magnet (150). As the plunger (118) moves toward the second end (116) of the chamber (112) into the unlocked position, the recess (124) is aligned with the detent (132) such that the detent (132) may retract into the recess (124), and the magnetic barrel lock assembly (100) may therefore be removed from a particular application.

In a basic form illustrated in FIG. 1, a magnetic north pole of the key magnet (148) is oriented near a magnetic north pole of the lock magnet (150), resulting in sufficient magnetic repulsion to overcome the resistance of the resilient member (134) and move the plunger (118). Conversely, removing the key magnet (148) from the key cavity (146) results in the resilient member (134) biasing the plunger (118) back into the locked position.

As one skilled in the art will appreciate, how “near” the key magnet (148) and lock magnet (150) must be in order to move the plunger (118) is dependent upon a variety of variables, including, the magnetic field strength of the key magnet (148) and lock magnet (150), the material composition of the cap (140), the thickness of a cap web (154), and the biasing force provided by the resilient member 134, for instance. In one embodiment, the key magnet (148) and the lock magnet (150) are positioned within one inch in order to move the plunger (118) into the unlocked position. The distance required to operate the magnetic barrel lock assembly (100) may be tailored to meet given application requirements, as understood by one skilled in the art.

In preferred forms, the key magnet (148) and the lock magnet (150) are permanent magnets made from a material having a high magnetic field to weight ratio, such as rare earth neodymium magnets. One skilled in the art, given the benefit of this disclosure, will appreciate the variety of magnet types and compositions suitable for use in accordance with the magnetic barrel lock assembly (100).

Turning to FIG. 2, a second example magnetic barrel lock assembly (200) is illustrated. In this example configuration, the magnetic barrel lock assembly (200) includes a lock body (210) defining an enclosed chamber (212) having a first end (214) and a second end (216). The lock body (210) is formed to include an upper portion (240) as opposed to the separate cap (140) as shown in FIG. 1.

A plunger (218) is located within the chamber (212) such that the plunger (218) can be moved axially between the locked position (shown in FIG. 1 in context of the magnetic barrel lock assembly (100)) and an unlocked position (shown in FIG. 2). As with the first example magnetic barrel lock assembly (100), the lock body (210), chamber (212), and plunger (218) may be configured with any number of similar or distinct form factors provided the plunger (218) is capable of moving within the chamber (212) between the locked and unlocked positions during operation of the magnetic barrel lock assembly (200).

The plunger (218) includes a head portion (220) near the first end (214) of the chamber (212), a shaft portion (222) adjacent the head portion (220), a recess (224) adjacent the shaft portion (222), and a lock portion (226) between the shaft portion (222) and the recess (224). An end face (236) of the plunger (218) is configured to engage an end face (238) of the chamber (212) near the second end (216) when the plunger (218) of the magnetic barrel lock assembly (200) is moved into the fully locked position (not shown). The plunger (218) further includes a recess (280) in the form of a longitudinal groove that is configured to engage a protrusion (282) in the form of a tongue extending from the lock body (210). The engagement between the recess (280) and the protrusion (282) inhibits relative rotation between the plunger (218) and the lock body (210) while allowing the plunger (218) to slide axially within the chamber (212).

When the plunger (218) is in the unlocked position (shown in FIG. 2), the recess (224) is aligned with a detent (232) in the form of a pin such that the detent (232) may retract toward the chamber (212) and into the recess (224) formed in the plunger (218). The detent (232) need not retract completely into the lock body (210) when the plunger is in the unlocked position, provided the appropriate allowance is made in the mating lock member, as understood by one of ordinary skill in the art. The recess (224) further defines a ramp (284) that the detent (232) cams against as the plunger (218) moves from the unlocked position shown in FIG. 2 to a locked position at which the detent (232) is extended.

In the example magnetic barrel lock assembly (200) illustrated in FIG. 2, a resilient member (234) is located near the first end (214) of the chamber (212) between an end face (252) of the chamber (212) and the plunger (218). The resilient member (234) is shown as a spring washer that flattens out under compression and rebounds to a dome shape to bias the plunger (218) toward the second end (216) of the chamber (212), thus maintaining the magnetic barrel lock assembly (200) in the locked position until desired.

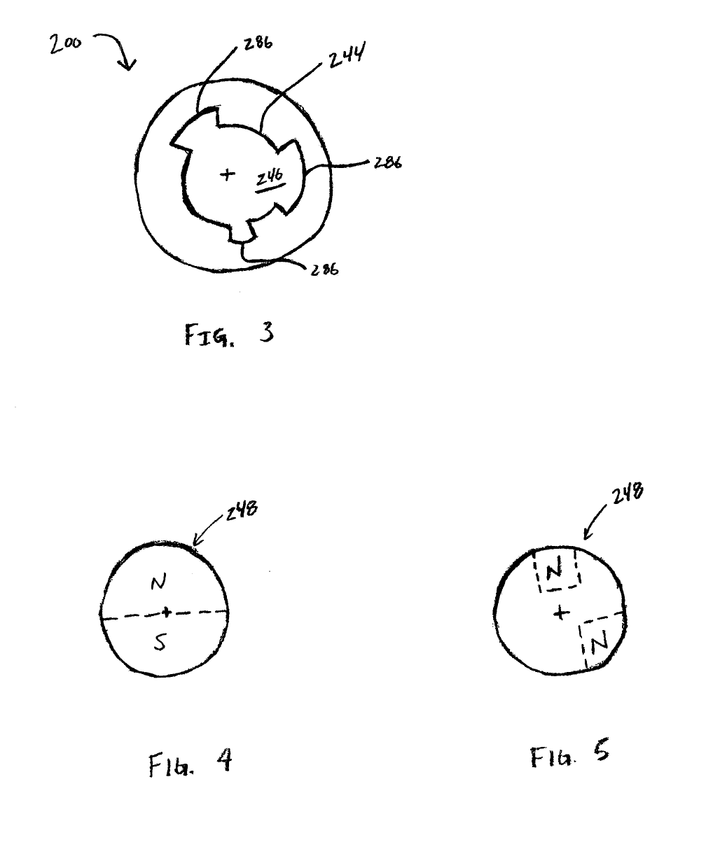

In the example embodiment shown in FIG. 2, the lock body (210) includes an integrated keyed opening (244) that provides further restricted access to a key cavity (246). As shown in FIG. 3, the example keyed opening (244) includes a series of notches (286) that match with a contoured head (288) of a key magnet (248), and provide an interlock configuration such that the key magnet (248) is selectively, axially captured to the lock body (210) to allow removal of the magnetic barrel lock assembly (200) from a mating lock member via the key magnet (248). For instance, a lip (292) of the key magnet (248) may be positioned within the key cavity (246) and rotated such that the lip (292) is adjacent one or more radially inward extending rims (294); attempting to remove the key magnet (248) when in this orientation results in the lip (292) engaging the rim (294) such that the key magnet (248) urges the entire magnetic barrel lock assembly (200) away from the mating lock member.

With continued reference to the example embodiment shown in FIG. 2, a lock magnet (250) is integral with the head portion (220) of the plunger (218). Converse to the magnetic barrel lock assembly (100), the lock magnet (250) is configured to magnetically interact with the key magnet (248) such that when the key magnet (248) is positioned into the key cavity (246) near the lock magnet (250), a lock magnet polarity and a key magnet polarity will attract the lock magnet (250) (and thus plunger (218)) toward the key magnet (248). Therefore, holding the key magnet (248) stationary within the key cavity (246) results in the lock magnet (250) being urged in the general direction of arrow F on FIG. 1, and thus moves the plunger (218) axially within the chamber (212) to the unlocked position. As the plunger (218) moves, the recess (224) is aligned with the detent (232) to allow the detent (232) to retract toward the chamber (212).

In one form, illustrated best in FIGS. 2 and 4, the key magnet (248) includes two magnets arranged generally into two halves of a disc and defines a key polarity code (i.e., N-S as oriented as shown in FIG. 4). The lock magnet (250) also includes two magnets arranged generally into two halves of a disc and defines a lock polarity code (i.e., N-S as oriented in FIG. 4). Inserting the key magnet (248) into the key cavity (246) and aligning the key magnet (248) such that the key polarity code is inverse of the lock polarity code (i.e., orienting the opposite N-S poles on the key magnet (248) and lock magnet (250), respectively, to maximize the attractive force) causes attraction between the key magnet (248) and lock magnet (250), which is integral with the plunger (218). The key magnet (248), lock magnet (250), and resilient member (234) are configured such that the magnetic attraction is sufficient to move the plunger (218) into the unlocked position shown in FIG. 2.

In the embodiment shown in FIGS. 2 and 3, the contoured head (288) of the key magnet (248) is inserted through the keyed opening (244) and into the key cavity (246) toward the first end (214) of the chamber (212). To provide additional security, the key cavity (246) may include one or more walls (290) that restrict rotation of the key magnet (248) and limit key magnet (248) orientations that result in operational interaction between the key magnet (248) and a lock magnet (250) integrated into the head portion (220) of the plunger (218). For instance, FIG. 5 illustrates an alternative key magnet (248) and lock magnet (250) polarity code, in which aligning the two off-center north magnetic poles repels the lock magnet (250) from the key magnet (248), such as in the magnetic barrel lock assembly (100) shown in FIG. 1. The configuration of unique polarity codes defining the magnetic interaction between the key magnet (248) and the lock magnet (250), and the various keyed opening (244) form factors provide numerous combinations for a robust magnetic barrel lock assembly (200), as will be appreciated by one of ordinary skill in the art in view of this disclosure.

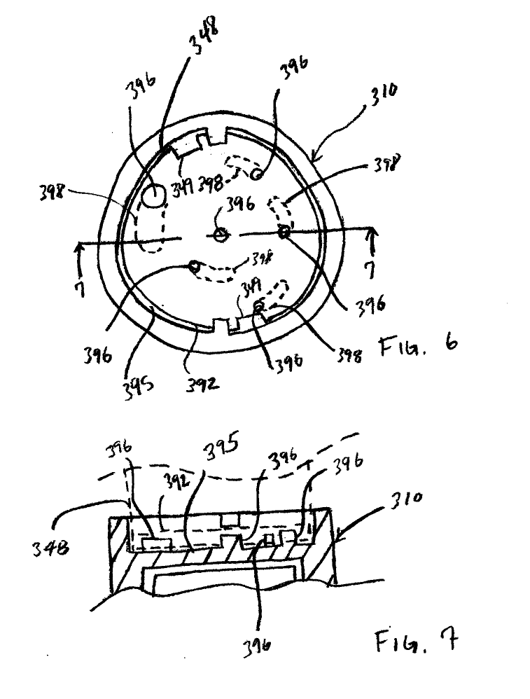

Another example interlock configuration generally between a lock body (310) and a key magnet (348) is illustrated in FIGS. 6 and 7. In the example shown, the lock body (310) includes an axial face (395) from which a series of cylindrical standoffs (396) extend at various locations. A key magnet (348) for use with the specific interlock configuration includes as series of mating radial slots (398) (shown as dashed lines in FIG. 6). In operation, the counterclockwise ends of the respective radial slots (398) are aligned with the standoffs (396), and notches (349) are aligned with respective rims (394). The key magnet is then rotated counterclockwise (as shown in FIG. 6) until the standoffs (396) abut the clockwise ends of the radial slots (398). In this orientation, a lip (392) of the key magnet (348) is aligned adjacent the rims (394) extending radially inward such that the key magnet (348) is axially captured to the lock body (310) and can be used to remove the lock body (310) from the particular lock member. The height of the standoffs (396) as measure relative to the axial face (395) can be varied as required to prevent a non-interlocking key magnet from being placed near enough to magnetically cause the magnetic barrel lock assembly to more to the unlocked position. Moreover, the number, placement, and form factor of the standoffs (396) may be varied, as understood by one skilled in the art given the benefit of this disclosure.

While there has been shown and described what is at present considered the preferred embodiments of the invention, it will be obvious to those skilled in the art that various changes and modifications can be made, given the benefit of this disclosure, without departing from the scope of the invention defined by the following claims.

We claim:

1. A magnetic barrel lock assembly, comprising:
a lock body defining a chamber having a first end and a second end opposite the first end;
a plunger located within the chamber moveable between a locked position and an unlocked position;
a lock magnet located between the plunger and the first end of the chamber;
a resilient member configured to bias the plunger toward one of the first end and the second end of the chamber; and
a detent configured to be extendable when the plunger is in the locked position and retractable when the plunger is in the unlocked position;
wherein positioning a key magnet near the lock magnet moves the plunger to the unlocked position such that the detent may retract.

2. The magnetic barrel lock assembly of claim 1, wherein:
the resilient member is located between the plunger and the second end of the chamber to bias the plunger toward the first end of the chamber; and
positioning the key magnet near the lock magnet moves the plunger toward the second end of the chamber.

3. The magnetic barrel lock assembly of claim 1, wherein:
the resilient member is located between the plunger and the first end of the chamber to bias the plunger toward the second end of the chamber; and
positioning the key magnet near the lock magnet moves the plunger toward the first end of the chamber.

4. The magnetic barrel lock assembly of claim 1, wherein the lock body further comprises a cap defining the first end of the chamber.

5. The magnetic barrel lock assembly of claim 4, wherein:
the cap defines a keyed opening and key cavity; and
the key magnet is configured to pass through the keyed opening into the key cavity adjacent the first end of the chamber.

6. The magnetic barrel lock assembly of claim 1, wherein the resilient member is at least one of a compression spring, a spring washer, and an elastomeric member.

7. The magnetic barrel lock assembly of claim 1, wherein the lock magnet is integral with the plunger.

8. The magnetic barrel lock assembly of claim 1, wherein the detent is at least one of a ball, a pin, and a block.

9. The magnetic barrel lock assembly of claim 1, wherein the plunger includes a recess configured to receive the detent when in a retracted position.

10. The magnetic barrel lock assembly of claim 1, wherein the lock magnet defines a lock polarity code that is inverse of a key polarity code defined by the key magnet.

11. The magnetic barrel lock assembly of claim 1, wherein:
the lock polarity code defines more than one lock magnet polarity, wherein at least one of the lock magnet polarities is distinct from an adjacent lock magnet polarity;
the key polarity code defines more than one key magnet polarity, wherein at least one of the key magnet polarities is distinct from an adjacent key magnet polarity.

12. The magnetic barrel lock assembly of claim 1, further comprising:
a protrusion extending from the lock body; and
a recess formed in the plunger;
wherein the protrusion and the recess are configured to slideably engage as the plunger moves within the chamber.

13. The magnetic barrel lock assembly of claim 1, further comprising:
a lip extending from the key magnet; and
a rim extending from the lock body;
wherein positioning the key magnet near the lock magnet engages the lip and the rim such that the key magnet is axially captured to the lock body.

14. The magnetic barrel lock assembly of claim 1, further comprising:
one or more standoffs extending from the lock body; and
one or more openings formed in the key magnet;
wherein a location of the one or more openings formed in the key magnet are aligned with the one or more standoffs when the key magnet is positioned near the lock magnet.

15. The magnetic barrel lock assembly of claim 14, wherein:
the one or more standoffs are cylindrical; and
the one or more openings are radial slots.
